(19) United States
(12) Patent Application Publication
(10) Pub. No.: US 2009/0039582 A1
(43) Pub. Date: Feb. 12, 2009

(54) Pipe Vise and Pipe Vise Adapter for Level Surface

(76) Inventor: Shannon McKeirnan, Ramona, CA (US)

Correspondence Address: BUCHE & ASSOCIATES, P.C., 875 PROSPECT, SUITE 305, SUITE 205, LA JOLLA, CA, 92037, US

(21) Appl. No.: 11/837,345

(22) Filed: Aug. 10, 2007

(51) Int. Cl. B25B 1/06

(52) U.S. Cl. 269/216

(57) ABSTRACT

A pipe vise and pipe vise adapter that mounts the vise perpendicular to a mounting surface and optionally incorporates the mounting surface as a part of the securing means.

### CROSS-REFERENCE TO RELATED PATENTS

Not Applicable

### STATEMENT REGARDING FEDERALLY SPONSORED RESEARCH OR DEVELOPMENT

Not Applicable

### BACKGROUND OF THE INVENTION

1. Field of Invention

The present application relates to the field of pipe vises, vise adapters and level work surfaces.

2. Background of the Invention

Vises are mechanical apparatus used to secure an object in place in order to effectively perform work on the object. In its most basic form, a vise consists typically of two surfaces, called jaws, which are brought together by a screw mechanism in order to physically secure an object in place between the jaws. The field of applications in which a vise may be employed can range anywhere from woodworking to electrical work, metalwork, jewelry or fly-tying to surfboard repair. A vise may potentially be used in a great number of ways, depending upon the vise itself and the type of application the vise was designed for.

Vises have been designed for numerous specific applications. Thus, there are multiple varieties of vises, such as hand vises, angle vises, rotary vises and pin vises, to name a few. One such variety, the pipe vise, incorporates a pipe into the design of the vise. This allows the vise to be employed in numerous locations and with varying size capacity depending upon the length of pipe used. However, the pipe vise currently cannot be mounted perpendicular to the working surface of a workbench or other level surface and optionally incorporate the working surface as part of the securing means.

### SUMMARY OF THE INVENTION

Accordingly, it is an object of the present application to provide a pipe vise and pipe vise adapter that mounts a pipe vise perpendicular to a mounting surface and optionally incorporates the mounting surface as a part of the securing means.

It is yet another objective of the present application to provide a pipe vise.

It is yet another objective of the present application to provide a pipe vise adapter.

It is yet another objective of the present application to provide a pipe vise adapter that mounts a pipe vise perpendicular to a mounting surface.

Other objectives of the invention will become apparent to those skilled in the art once the invention has been shown and described. These objectives are not to be construed as limitations of applicant's invention, but are merely aimed to suggest some of the many benefits that may be realized by the apparatus of the present application and with its many embodiments.

### BRIEF DESCRIPTION OF THE DRAWING

The manner in which these objectives and other desirable characteristics can be obtained is explained in the following description and attached drawings in which:

FIG. 1 is a perspective drawing of a preferable pipe vise and pipe vise adapter being used to secure an object between the moveable jaw mechanism and the base plate.

FIG. 2 is a perspective drawing of a preferable pipe vise and pipe vise adapter being used to secure an object between the moveable jaw mechanism and a mounting surface.

FIG. 3 is a perspective drawing of a preferable pipe vise adapter.

It is to be noted, however, that the appended drawings illustrate only typical embodiments of this invention and are therefore not to be considered limiting of its scope, for the invention may admit to other equally effective embodiments that will be appreciated by those reasonably skilled in the relevant arts. Also, drawings are not necessarily made to scale but are representative.

### DETAILED DESCRIPTION OF THE INVENTION

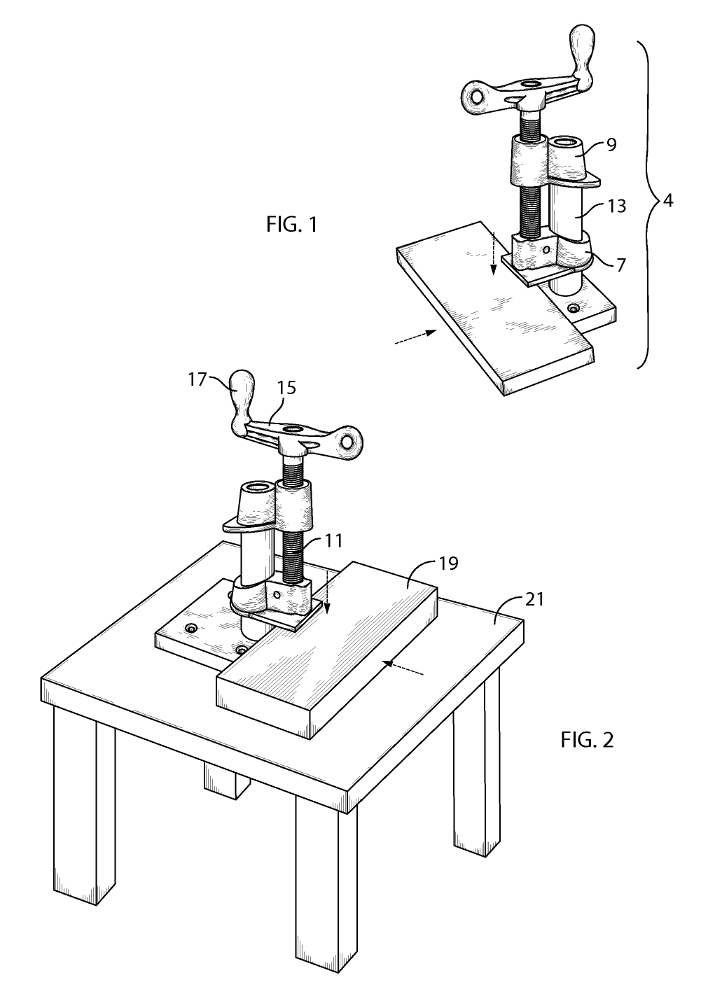

FIG. 1 is a 4 and pipe vise adapter 2 being used to secure an object between perspective drawing of a preferable embodiment of a pipe vise the moveable jaw mechanism 7 and the base plate 1. Basic components of the pipe vise 4 and pipe vise adapter 2 comprise a pipe 13, secured pipe clamp 9, moveable jaw mechanism 7, spindle 11, lever mechanism 15 and base plate 1. The basic components of the pipe vise 4 and pipe vise adapter 2 may be made of any rigid material such as metal or any other compound having similar attributes. A preferable mode of use is that the secured object 19 is placed between the base plate 1 and moveable jaw mechanism 7. The secured object 19 may be held in this position firmly between the base plate 1 and moveable jaw mechanism 7 once the moveable jaw mechanism 7 is lowered to exert pressure on the secured object 19. The moveable jaw mechanism 7 may be lowered by rotating the lever mechanism 15 until the desired pressure is achieved upon the secured object 19.

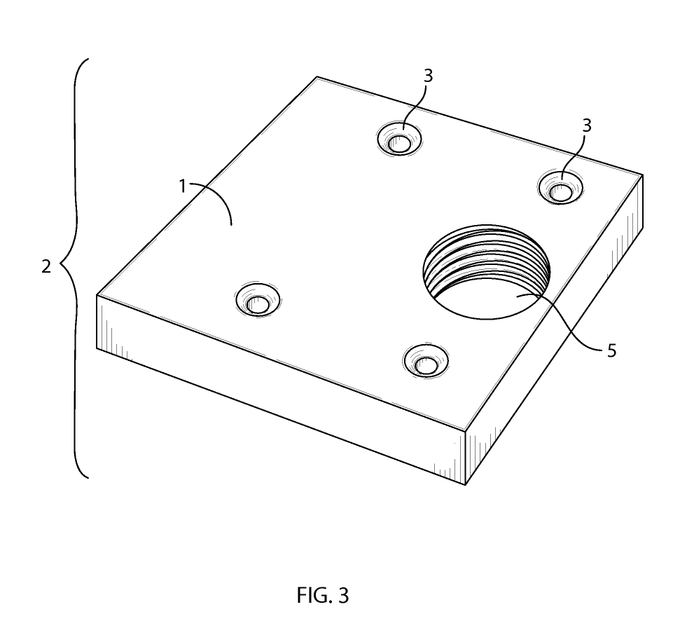

FIG. 2 is a perspective drawing of a preferable embodiment of a pipe vise 4 and pipe vise adapter 2 being used to secure an object between the moveable jaw mechanism 7 and the mounting surface 21. The pipe vise adapter 2 is secured to the mounting surface 21 using screws inserted through the beveled screw receivers 3, or optionally, by other means including, but not limited to, bolts, nails, chemical adhesives, gravity, or other such affixing means. The mounting surface 21 may be any flat surface such as, but not limited to, a tabletop or floor and may be made of any rigid material such as any variety of metal, plastic, concrete, stone, wood or other compound having these qualities. FIG. 2 is a preferable mode of use in that the secured object 19 may be held in this position firmly between the mounting surface 21 and moveable jaw mechanism 7 once the moveable jaw mechanism 7 is lowered to exert pressure on the secured object 19.

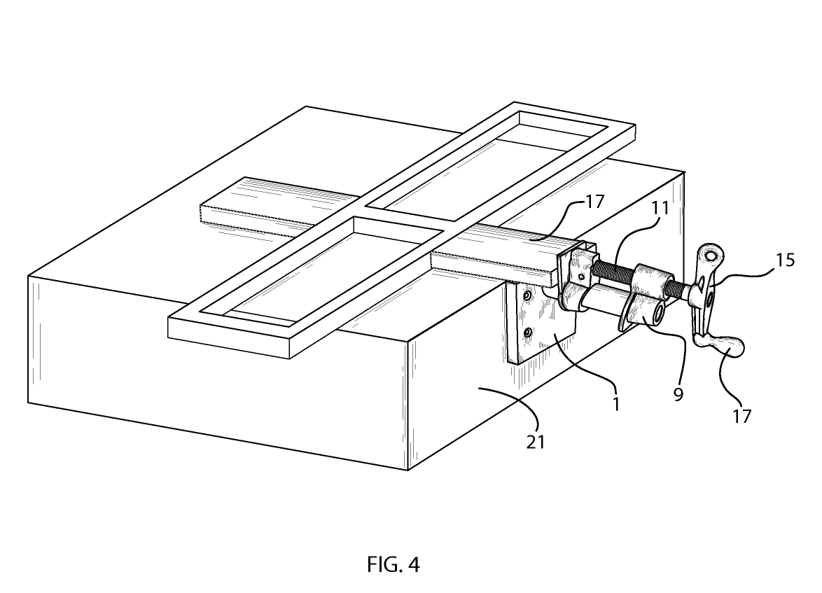

FIG. 3 is a perspective drawing of a pipe vise adapter 2. The pipe vise adapter 2 may be made of any rigid material such as metal or any other compound having similar attributes. Basic components of the pipe vise adapter 2 include the base plate 1, beveled screw receivers 3 and the threaded pipe receiver 5. The pipe vise adapter 2 may be mounted to any flat surface such as, but not limited to, a tabletop or floor and may be made of any rigid material such as any variety of metal, plastic, concrete, stone, wood or other compound having these qualities. The pipe vise adapter 2 may be secured to the mounting surface 21 using screws inserted through the beveled screw receivers 3, which maintains a flat surface across the plane of the base plate, or optionally, by other means including, but not limited to, bolts, nails, chemical adhesives, gravity or other such affixing means. The threaded pipe receiver 5 may be configured to receive a particular size pipe 13, and optionally, the base plate 1 may contain multiple threaded pipe receivers 5 to accommodate a variety of pipe 13 sizes.

FIGS. 1, 2, and 3 depict a pipe vise 4 mounted perpendicular to a mounting surface 21 and optionally incorporates the mounting surface 21 as a part of the securing means. As shown in FIG. 3, threaded pipe receiver 5 is suitably located relative to the base plate 1 such that when pipe 13 occupies threaded pipe receiver 5, the pipe clamp 9 and movable jaw 7 may be adjusted to optionally position the clamping surface of the movable jaw 7 above the mounting surface 21 (FIG. 2) or the base plate 1 (FIG. 1). In FIGS. 1 and 2, optional positioning of the clamping surface of the movable jaw is accomplished through contemporaneous rotation of the pipe clamp 9 and the movable jaw 7 radially around the pipe 13. Alternatively, optional positioning may also be accomplished by rotating the pipe 13, pipe clamp 9, and the movable jaw 7 radially around the threaded pipe receiver 5. Other means for accomplishing this optional positioning will be known to those having skill in the art. In FIG. 4, pipe vice 4 is optionally mounted so that the base plate 1 is vertically oriented and securable to a mounting surface 21, and so that the pipe vice adaptor 2 may be used to apply pressure to a secured object 19 from an alternate direction, in this case a horizontal direction. This capability will be appreciated by those skilled in the arts, particularly of cabinet making.

It is to be noted, however, that the appended drawings illustrate only typical embodiments of this invention, are not to scale, and are therefore not to be considered limiting of its scope, for the invention may admit to other equally effective embodiments which are appreciated by those skilled in the arts.

I claim:

1. A pipe vise comprising:
at least one pipe vise adapter having a base plate;
at least one pipe removably fixed to said pipe vise adapter;
at least one means for removably fixing said pipe to said pipe vise adapter;
a pipe clamp selectively secured to said pipe;
said pipe clamp having an integral jaw wherein said jaw has at least one surface which defines a clamping surface;
means for selectively moving said jaw any direction parallel to the axis of said pipe;
means for optionally positioning said clamping surface relative to said base plate; and,
means for removably securing said pipe vise adapter to a surface.

2. The pipe vise of claim 1 where in said pipe is perpendicular to said base plate.

3. The pipe vise of claim 1 wherein said integral jaw is positioned between said pipe clamp and said base plate.

4. The pipe vise of claim 3 wherein said pipe clam is vertically fixed to the distal end of said pipe.

5. The pipe vise of claim 1 wherein said means for removably fixing said pipe to said pipe vise adapter is at least one aperture.

6. The pipe vise of claim 1 wherein said means for removably fixing said pipe to said pipe vise adapter is at least one threaded pipe receiver.

7. The pipe vise of claim 4 wherein said means for removably fixing said pipe to said pipe vise adapter is at least one threaded pipe receiver.

8. The pipe vise of claim 1 wherein said means for selectively moving said jaw any direction parallel to the axis of said pipe is a threaded spindle and lever mechanism.

9. The pipe vise of claim 4 wherein said means for selectively moving said jaw any direction parallel to the axis of said pipe is a threaded spindle and lever mechanism

10. The pipe vise of claim 7 wherein said means for selectively moving said jaw any direction parallel to the axis of said pipe is a threaded spindle and lever mechanism

11. the pipe vise of claim 1 wherein said means for removably securing said pipe vise adapter to a surface is at least one rigid rod shaped piece passing within said pipe vice adapter or surface.

12. the pipe vise of claim 4 wherein said means for removably securing said pipe vise adapter to a surface is at least one rigid rod shaped piece passing within said pipe vice adapter or surface.

13. the pipe vise of claim 7 wherein said means for removably securing said pipe vise adapter to a surface is at least one rigid rod shaped piece passing within said pipe vice adapter or surface.

14. the pipe vise of claim 9 wherein said means for removably securing said pipe vise adapter to a surface is at least one rigid rod shaped piece passing within said pipe vice adapter or surface.

15. the pipe vise of claim 10 wherein said means for removably securing said pipe vise adapter to a surface is at least one rigid rod shaped piece passing within said pipe vice adapter or surface.

16. the pipe vise of claim 1 where in said means for removably securing said pipe vise adapter to a surface is at least 1 nail.

17. the pipe vise of claim 1 wherein said means for removably securing said pipe vise adapter to a surface is at least 1 screw.

18. a method for mounting a pipe vice relatively perpendicular to a surface comprising:
removably attaching a pipe to a pipe vise adapter having a base plate wherein said pipe is perpendicular to said base plate;
removably securing said pipe vise adapter to a surface; and,
installing a pipe vise clamp and integral moving jaw having at least one clamping surface and a means for selectively moving said jaw either direction parallel to the axis of said pipe.

19. the method of 16 wherein said pipe vise is mounted to optionally use said surface as a clamping surface by said pipe vise clamp further having a means for optionally positioning said clamping surface relative to said base plate.
